(19) United States
(12) Patent Application Publication
(10) Pub. No.: US 2002/0054090 A1
(43) Pub. Date: May 9, 2002

(54) Method and apparatus for creating and providing personalized access to web content and services from terminals having diverse capabilities

(76) Inventors: Juliana Freire Silva, Murray Hill, NJ (US); Bharat Kumar, Bridge Water, NJ (US); Daniel Francis Lieuwen, Somerville, NJ (US)

Correspondence Address: Lucent Technologies Inc., Docket Administrator (Room 3J-219), 101 Crawfords Corner Road, Holmdel, NJ, 07733-3030, US

(21) Appl. No.: 09/943,133

(22) Filed: Aug. 30, 2001

Related U.S. Application Data
(60) Provisional application No. 60/229,681, filed on Sep. 1, 2000.

(51) Int. Cl. G09G 5/00

(52) U.S. Cl. 345/747

(57) ABSTRACT

A personalized Web view of content in a Web page is created for later access by users through diverse terminals having different types of processing and display capabilities. The Web view provides a shortcut to specific content and services, which a user is interested in retrieving through limited bandwidth, high latency “thin” devices such as PDAs and WAP phones. Further, the Web view is customized to the specific type or types of devices that the user will use to access the Web view. In creating the Web view from a client terminal, a user accesses the Web page containing the information of interest either directly or by recording a series of navigation steps used to reach a final Web page from a first Web page. One or more extraction expressions for extracting the components of interest are generated and a Web view specification is created and saved at a Web view server that includes the navigation steps, the extraction expressions and an association between the extraction expressions and the specific types of devices on which the personal Web view will be displayed. When the Web view server later receives a request for the Web view from an originating device, the request includes the type of the originating device. The server then retrieves the stored specification, accesses the page indicated in the specification through the one or more navigation steps, extracts the one or more components relevant for the type of device indicated in the request, and returns the extracted components to the originating device.

### CROSS-REFERENCE

This application claims the benefit of U.S. Provisional Application Serial No. 06/229,681, filed September 1, 2000.

### TECHNICAL FIELD

This invention relates to creating, accessing and providing Web content and services from and to different types of terminals having various information handling and presentational capabilities.

### BACKGROUND OF THE INVENTION

Wireless devices that can access Web content and services are predicted to become omnipresent in the next few years. Shortly, millions of people will be able to access the Web and order services and goods from wireless Internet devices. However, the existing Web infrastructure and content were designed for desktop computers and are not well suited for devices having less processing power and memory, small screens, and limited input devices. In addition, wireless data networks provide less bandwidth, have high latency and are not as stable as traditional wired networks.

For example, if one were to access the Web from a personal digital assistant (PDA) with wireless capabilities, throughput rates may vary from 5-6 kbps up to 12-13 kbps using a wireless data service such as Omnisky that runs over CDPD, a wireless IP network that overlays on the existing AMPS (analog) cellular infrastructure. With a screen size of 160×160 pixels on a 6×6 cm surface, it can be very hard to browse through large pages with rich graphics. Given that these devices have significantly less memory and processing power than desktop computers, the available browsers only have a small subset of the features of widely used desktop browser (e.g., they do not support Java, Javascript, and are unable to display GIF or JPEG images). In addition, input facilities are limited and entering text can be very time consuming. Similar difficulties arise while trying to access the Web using Wireless Access Protocol (WAP) phones (Internet-ready mobile phones). Newer additions to the PDA family have more memory, powerful processors, and could eventually have more complete browser support; however, the screen size, limited input capabilities, an high latency for page accesses still apply.

Voice interfaces have recently received much attention as an effective means of user interaction, which both simplifies the input process and provides more convenient and hands-free access. The advances in voice recognition and text-to-speech (TTS) processing, combined with the steady increase in computing power has made these technologies viable for end-users. Standards such as Voice eXtensible Markup Language (VoiceXML) have been proposed for making Web content and information accessible via voice and phone. Even though there are some VoiceXML-based services available, most content on the Web consists of HTML pages and cannot be easily accessed through voice interfaces.

The reality is that the Web is not really accessible anytime or anywhere. Different attempts have been made to address these shortcomings. In order to address these limitations of bandwidth, screen real estate, and input facilities, three different approaches/models are currently in use. In a first approach, content providers create different versions of their Web sites that provide content that is formatted for specific devices. For example, some sites provide specialized interfaces for Web-enabled phones and for PDA devices. In a second approach, third-party services such as everypath.com and oraclemobile.com provide tools and services to creates wrappers which export wireless-friendly clippings of a set of Web pages and services, such as stock quotes, traffic, and weather information. These wrappers require no modifications to the underlying Web sites. In a third approach, proxies can be programmed to transform content according to a client's display size and capabilities. For example, ProxiWeb (http://www.proxinet.com) transforms HTML pages and embedded figures into a format that can be displayed on a Palm Pilot PDA.

All of these approaches have drawbacks. From a content provider's perspective, having to create and maintain multiple versions of a Web site to support different devices is labor intensive and can be very expensive. Even though wrappers require no modifications to the underlying Web sites, they can be costly to create and need updating whenever the corresponding Web site or service changes. From a user's point of view, both of these solutions are restrictive, as neither all Web sites support all kinds of devices, nor do wrapper-based solutions offer clippings for all content or services a user may need.

Proxy transcoders, on the other hand, perform on-the-fly content translation and, in theory, they are a good general solution for allowing users to browse virtually any Web site. But since Web pages must be presented as faithfully as possible, these general-purpose proxies do not perform any personalization. This is not the ideal solution for someone accessing the Web through a cellular phone with a 3-line display. Besides, some features are hard or even impossible to translate. It is not unusual that proxies fail to properly transcode complex pages, or even simple, but badly designed pages.

### SUMMARY OF THE INVENTION

In accordance with the present invention, an end-user is able to create and maintain a personalized Web view of one or more Web sites, which is customized for presentation on specific types of devices that will be used to access the Web view. In particular, the Web view server of the present invention provides a platform through which such Web views are created and then later accessed by devices which may have limited bandwidth and high latency, and which will be referred to herein as “thin” clients. These customized Web views provide shortcuts to specific content and services in which a user (or a group of users) is interested in retrieving through such a thin client. By allowing users to create their own Web views, a service is provided that is personalized for that user and is not restricted to a set of supported Web sites. Further, such Web views, when created, are customized for the specific type or types of devices through which the user will thereafter use to access the view. Thus, for example, a limited-sized Web view can be created for display on the screen of the specific type of wireless device used by the end-user to access Web content and/or services. As another example, a Web (or voice) view is created for user access through a telephone terminal that produces better quality content, and a more user-friendly experience. Advantageously, the shortcuts to specific content provided through such personalized Web or voice views can significantly reduce the number of required interactions and the amount of data transferred between a thin device such as PDA, an Internet-ready mobile phone or a standard telephone set, and the Web site from which information of services are desired.

Essentially any Web page can be selected by a user to be the source of a personalized Web view. In creating a Web view for later replay, the user accesses the one or more source Web page of his interest and extracts the component or components within each source page that he wants included within the personalized Web view. Depending upon what type of device the Web view will be later presented, different components may be extracted. Then later, when a particular type of device retrieves the Web view through the Web view server, the source Web page or pages are retrieved and the components defined in the Web view specification in association with that particular type of device are extracted and presented to the user on his device in a format that is appropriate to that device. The creation of a personal Web view through the extraction of components from a source page to form a Web clipping is the subject co-pending patent applications entitled “Method and Apparatus for Web-Site-Independent Personalization From Multiple Sites Having User-Determined Extraction Functionality”, Ser. No. 09/650,512, and “Method and Apparatus for Web-Site-Independent Personalization From Multiple Sites Having User-Determined Individual Refresh Rates”, Ser. No. 09/650,144, both filed on Aug. 29, 2000, and both incorporated herein by reference.

### BRIEF DESCRIPTION OF THE DRAWING

FIG. 1 is a block diagram of a system that incorporates the present invention;

FIG. 2 is an example of a Web view specification in accordance with the present invention;

FIG. 3 is an example of a Web page from which different content is extracted according to the type of device accessing a Web view;

FIG. 4 is an example of another Web page from which content is extracted;

FIG. 5 is a flowchart that summarizes the steps used to create a personalized Web view for diverse terminals, in accordance with the present invention;

FIG. 6 is a flowchart that summarizes the steps for accessing and replaying a Web view from a specified type of device in accordance with the present invention;

FIG. 7 shows the architecture of a voice transcoding embodiment of the present invention;

FIG. 8 shows the VoiceXML dialogue generated by the architecture in FIG. 7 for a clipping from the Web page shown in FIG. 4;

FIG. 9 is a flowchart that summarizes the steps of creating a Web view for VoiceXML applications in accordance with the present invention; and

FIG. 10 is a flowchart that summarizes the steps of replaying a stored Web view for VoiceXML in accordance with the present invention.

### DETAILED DESCRIPTION

The following scenario will help make the motivation for the present invention be understood. A user may plan to attend a particular conference in, for example, Hong Kong and needs to look for flights from Newark Airport from Newark Airport to Hong Kong that leave from Newark on April 29^{th}and return from Hong Kong on May 6^{th}. He goes to the Web site www.travelocity.com and after navigating through six pages, and having 650 Kb of data transferred (300 Kb with images turned off), a page with the list of nine flights (as well as ads and additional navigational information) is displayed. From a desktop browser, repeating this series of steps can be rather tedious if one performs this type of query often in an attempt to find a cheap flight. The problem is compounded as one tries to access the flight list from a wireless device such as PDA with a wireless modem. In fact, using a proxy that filters and reforms Web content according to a client's display size and capabilities is likely not to be able to transcode one or more of the pages correctly.

Accordingly, it is desirable to create a shortcut to the flight list. Since the final page also contains additional information beyond the flight list, it would also be useful to create from that page just the list of flights. The above noted and incorporated patent applications describe the methodologies for creating and accessing personalized Web views that are shortcuts that automatically extract and deliver personalized information to the user. The present invention extends the capabilities of these prior applications by creating shortcuts to different Web views of Web pages that are better suited to be accessed from different terminals. Thus, in the PDA scenario above, the shortcut could be executed at a Web view server (with a better connection to the Internet), and only the final results (the clipped flight list) delivered to the user's PDA. Ignoring latencies, downloading the 650 Kb required the access the flight list from Travelocity takes anywhere between 60 and 180 seconds over CDPD, whereas from a desktop computer connected to the Internet through a cable modem the transfer would take less than 5 seconds. Thus, by creating a shortcut and moving the processing to the Web view server, significant delays can be eliminated since only the clipped results need be transmitted to the thin PDA device.

The Web view architecture of the present invention enables users to create customized views of Web content and services for presentation on specific devices. In creating Web views, two main steps are involved: retrieving a Web page that contains the desired information, and extracting relevant content from the retrieved page. Given the growing trend of creating interactive Web sites that publish data on demand, retrieving information from the Web is becoming increasingly complicated. Many sites require users to fill a sequence of forms and/or follow a sequence of links to access a page that they need, and often, these hard-to-reach pages cannot be bookmarked using the bookmark facilities implemented by popular browsers. To create a Web view of these types of pages, the process to access the desired pages requires automation. Also, once a desired page is retrieved, the user may want to specify individual components of the page that he is interested in, so that irrelevant information is filtered out. The Web view encapsulates the actions required to retrieve a particular page, along with the specification of which components should be extracted from the retrieved page.

As described in the aforenoted co-pending patent applications, customized access scripts to access particular Web content can be generated from smart bookmarks or site descriptions, the latter being extensions of navigation maps. Smart bookmarks, and how they are created and replayed, are the subject of a co-pending patent application Ser. No. 09/387571 entitled “Method for Providing Fast Access to Dynamic Content on the World Wide Web”, filed Aug. 31, 1999, and in a paper entitled “Automating Web Navigation with the WebVCR”, by V. Anupam, J. Freire, B. Kumar and D, Lieuwen, Proc. of WWW, pages, 503-517, 2000, which are incorporated herein by reference. Navigation maps are the subject of co-pending patent application Ser. No. 09/263679 entitled “Method and Apparatus for Querying Dynamic Web Content”, co-pending patent application Ser. No. 09/263680 entitled “Method and Apparatus for Extracting Navigation Maps From Web Sites”, both filed Mar. 5, 1999, and a paper entitled “A Layered Architecture for Querying Dynamic Web Content”, by H. Davulcu, J. Freire, M. Kifer, and 1. Ramakrishnan, Proc. of SIGMOD, pages 491-502, 1999, which are both incorporated herein by reference. Site descriptions extend navigation maps in two significant ways: they provide more flexibility in the selection as well as format of retrieved information; and they also provide a finer-grained specification of input and output parameters for retrieving information from specific nodes in the site description graph. Site descriptions are the subject of a paper entitled “Personalizing the Web Using Site Descriptions” by V. Anupam, Y. Breitbart, J. Freire, and B. Kumar, Proceedings of DEXA Workshop 1999, pages 732-738, and is incorporated herein by reference.

From a desktop, using a browser and a WebVCR as detailed in the above-noted paper and the noted co-pending patent application relating to smart bookmarks, a user is able to create a Web view by simply browsing to the desired page and selecting on that page the components of interest—no programming is required. Furthermore, as detailed in the above-noted co-pending patent applications entitled “Method and Apparatus for Web-Site-Independent Personalization From Multiple Sites Having User-Determined Extraction Functionality” and “Method and Apparatus for Web-Site-Independent Personalization From Multiple Sites Having User-Determined Individual Refresh Rates”, the robustness of Web views is enhanced, so that they work even if certain changes occur in the underlying Web sites.

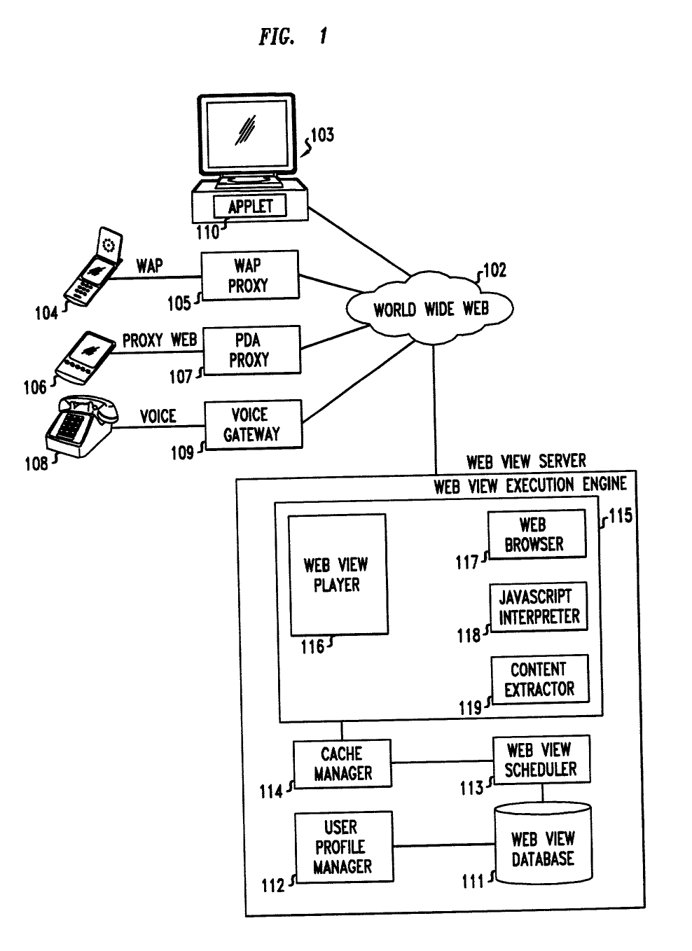

After a Web view is created, it can be accessed through a Web view server, which is a Web-hosted service located at an ISP, ASP, or a company intranet. FIG. 1 shows a Web view server 101 connected to the World Wide Web 102. Web views can be created by a user at a desktop 103 for later retrieval through the desktop, or for example, from a WAP phone 104 through a WAP proxy 105, from a wireless PDA 106 through a PDA proxy 107, or from a telephone set 108 through a voice gateway 109. The Web view server 101 accepts requests from HTTP clients and returns XHTML responses. A request to the Web view server 101 contains an identifier for a particular Web view (and additional parameters to be later discussed), which when executed, accesses a particular Web page, clips it, and returns the resulting content to the requesting client. The requesting clients, as shown in FIG. 1, can be proxy transcoders that translate the clipped content into various forms (e.g., HTML, WML, VoiceXML, etc.).

If the user wishes to create a Web view for the Travelocity scenario earlier described, he starts a Web view recorder applet 110 running on his desktop, or downloaded from a remote site. He then goes to the main Travelocity (www.travelocity.com) Web site, hits the Record button on the applet, and browses to the itinerary page. As soon as the Record button is clicked, the applet transparently records all his navigation actions. When the desired page is reached, he hits the Stop button, and specifies the content to be extracted from the final page (e.g., only the itinerary details). At this point, the Recorder applet has all the information required for the Web view, which can be saved. After it is uploaded to the Web view server 101, the Web view is then accessible to any HTTP client. When the user wants to access this view from his PDA 106, he accesses the Web view server 101, which after authenticating his request, automatically navigates to the itinerary page at the Travelocity Web site, extracts the specified content from the page, and returns the extracted XHTML content (which PDA proxy 107 transcodes before it reaches the user's PDA 106).

The Web views 101 server includes the following modules: 1) a Web view database 111, which stores Web view specifications; 2) a user profile manager 112, that performs user authentication for sensitive Web views stored on the server (e.g., a Web view that retrieves a user's 401(k) balance), as well as manages other aspects of the user's account; 3) a Web view scheduler 113, that periodically executes Web views (if so specified by the Web view requester); 4) a cache manager 114, that stores cached Web views; and 5) a Web view execution engine 1 15, that interacts with a Web view player 116, which together with a Web browser 117 and a Javascript interpreter 118, retrieves Web documents and parses HTML pages; and a content extractor 119, which clips the components of interest on the of retrieved Web page.

To create a Web view, a user first specifies the Web page to be clipped. If the page requires multiple steps in order to be retrieved and does not have a well-defined URL, the user can use the recorder component of the Web view applet 110 to create the script to access the page. Using a VCR-style interface to transparently record browsing actions, a users can simply navigate his way to the final page while his actions (links traversed, forms filled along with the user inputs, and any other interactions with active content) are transparently recorded and saved in a smart bookmark.

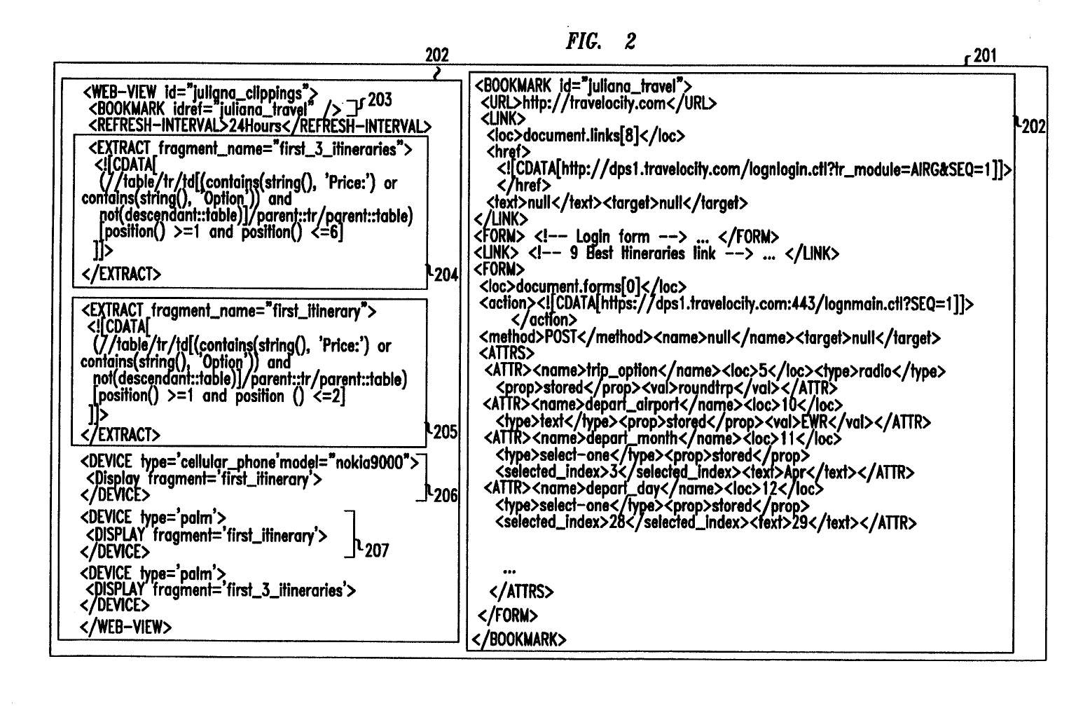

As described in the afore-noted co-pending patent application relating to smart bookmarks, during recording, if the user is required to fill out forms, he can optionally specify which field values are to be stored in the Web view specification itself, and which ones are to be requested from the user every time the Web view is executed. This allows the user to create parameterized Web views. For example, a Web view to retrieve a restaurant list from the Yellow Pages at http://www.mapsonus.com can have a zip code parameter, so the user does not need to create a separate Web view for each city. Also, for security reasons, a user may choose not to save certain kinds of information such passwords inside a Web view (parameterization issues will be discussed hereinbelow), or to save it encrypted. FIG. 2 shows a Web view specification 201 for the Travelocity scenario earlier presented. The specification 201 includes smart bookmark 202 that is used to retrieve the itinerary page from the Web site http://www.travelocity.com.

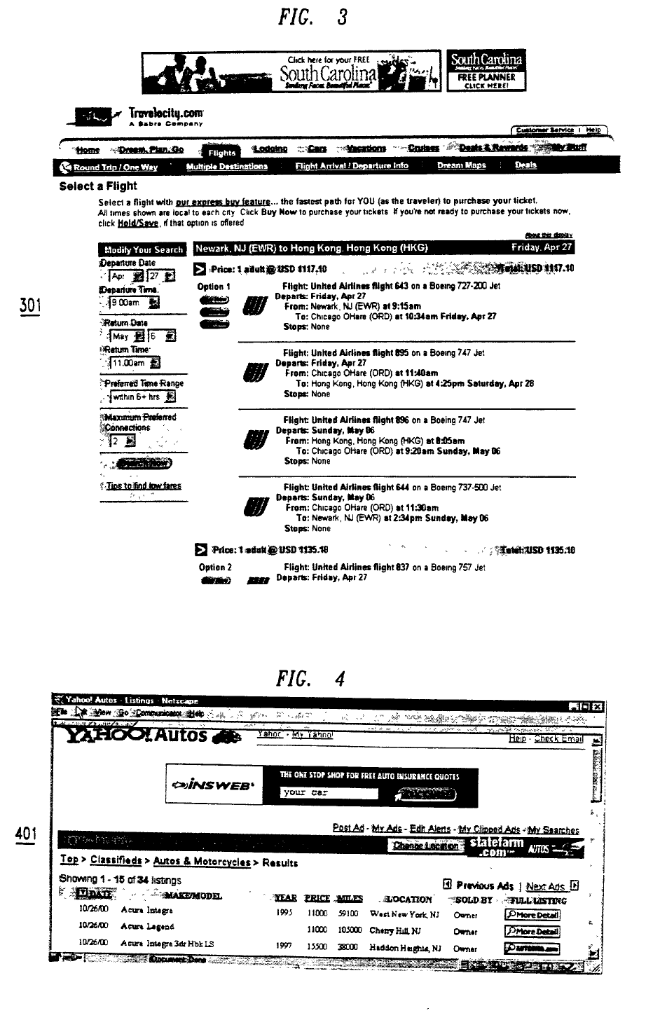

Once a desired page is retrieved (such as the exemplary Travelocity page 301 shown in part in FIG. 3), a clipping component of the Web view applet 110 can be used to specify the fragments of the page to be extracted. Identifying these fragments can be done in several ways. In general, any extraction specification needs to provide the ability to 1) address individual or groups of arbitrary components in a page, and 2) specify rules (that use the above addressing scheme) to extract the relevant content from the page. Such an extraction specification advantageously should be standard, powerful, portable and efficient, and most importantly, one that can be used to easily create robust extraction expressions (i.e., that will not break under minor changes to page structure).

XPath (see, e.g, http://www.w3.org/TR/xpath for a description of the XPath language) is an example of a mechanism for specifying extraction expressions. XPath views an XML document as a tree and provides a flexible mechanism for addressing any node in this tree. One drawback of using XPath, however, is its requirement that pages be well formed. Since browsers are very forgiving in this respect, many Web sites generate pages that are ill formed (e.g., have overlapping tags, missing end tags, etc.). Consequently, the Web view system must first clean up HTML pages (e.g., using tools such as HTML Tidy [see, e.g., http://www.w3.org/People/Raggett/tidy]) before XPath can be applied. Another alternative for specifying extraction expressions is the XML DOM API. However, XPath allows a more flexible and easier way to create robust clipping expressions that are immune to minor changes in page structure. DOM addresses (without storing extra information, or using other heuristics to compensate for page changes) can be very brittle even to minor layout changes.

Returning to the exemplary Travelocity scenario, the user may only be interested seeing the first three itineraries from Travelocity (where each itinerary is represented by two HTML tables—one with pricing information, the other with route information). After recording the navigation steps, the user specifies an XPath expression that will extract only the desired content from the final page. For example, the user could use either of the following expressions:

//html/body/center[2]/div/table[2]/tr/td/table[position()>=3 and position()<=8] (1)

//table/tr/td[(contains(string(),‘Price:’) or contains(string(),‘Option’)) and not(descendant::table)]/parent::tr/parent::table[position()>=1 and position()<=6] (2)

As can be noted, these expressions can be complicated, and writing them can be an involved task. In addition, there are multiple ways to specify a particular page component, and some may be preferable to others in terms of robustness. Since the Web view system is directed towards the naive user, it is unlikely that he would be able to specify XPath expressions. Accordingly, a point-and-click graphical user interface (GUI) that lets users select portions of Web pages (as they see them in the Web browser) and automatically generate extraction expressions is a superior methodology for extracting components from a document. The point-and-click interface provides users with different levels of abstraction corresponding to a breadth-first search in the portion of the document tree that is visible in the browser. For example, if a user is interested in particular cells of a table, he must first select the table and then zoom into the table to select the desired cells. Additional detail on how the GUI produces XPath expressions and other clipping information is provided hereinafter.

With reference again to FIG. 2, a Web view specification for the Travelocity scenario example is shown. As earlier noted, the specification includes a smart bookmark 201 identified by id=“juliana_travel”, for the “9 Best Itineraries link“at the Travelocity Web cite. The Web view specification further includes an extract data specification 202, which defines what information is to be extracted from the source bookmarked page as a function of the type of device on which the extracted information is to be displayed. The first part of the extraction specification 202, on line 203, points to the smart bookmark 201 that retrieves the desired page. The <EXTRACT> expressions 204 and 205 contain different extraction specifications that may be applied for displaying the extracted information on a PDA device and a WAP telephone, respectively. For example, as shown, if the Web view is to be displayed on a PDA, the first 3 itineraries (the extraction tag in 204 with fragment_name=“first_{—}3_itineraries”) are chosen to be displayed. If the Web view is to be displayed in a Web-enabled cellular phone with a 3-line display, only a single itinerary is chosen to be displayed (e.g., the extraction tag in 205 with fragment₁₃name=“first_itinerary”). The <DEVICE> expressions 206 and 207 link the device on which the extracted information is to be displayed with the particular extraction expressions 204 and 205. Thus, as noted in FIG. 2, if the device is, for example, a Nokia model 9000 Web-enabled cellular phone, the extraction expression it is linked with is 205 via the <DISPLAY fragment=“first itinerary”> statement. Similarly, if the PDA device is a Palm Pilot, the extraction expression it its linked with is 204 via the <DISPLAY fragment=“first_{—}3_-itineraries”> statement.

After a Web view is specified, it can be saved and uploaded to the Web view server 101. Users may then access Web views via URLs that uniquely identify them and identify the type of devices on which a Web view is to be displayed. Users may further specify additional parameters such as input values for a Web view (e.g., the password to access a bank account); the mode of operation (pull or push); whether the Web view should be cached and how often it should be refreshed. Given the Web's unpredictable behavior (network delays, unreachable sites, etc.), caching plays an important role in a Web view server. Users can specify for each Web view, if and how often it should be executed and cached (e.g., execute the Web view in FIG. 2 every 24 hours, as noted in the <REFRESH-INTERVAL> statement 208, and cache the itineraries).

In addition, users may also specify how they want the Web view to be delivered. In the pull mode, the URL invokes a CGI script at the Web view server 101, which in turn executes the Web view specification in FIG. 2 and immediately returns the clipped content to the requesting client. In the push mode, the execution and delivery of the Web view are asynchronous, i.e., the Web view can be returned to the client later, possibly through protocols other than HTTP (e.g., Web views could be emailed). The push mode is preferable when back-end Web sites are slow or temporarily unreachable, or when the end user cannot or does not want to keep a session open for too long where, for example, a wireless data service provider charges for usage time.

The execution of a Web view is as follows. The smart bookmark in the Web view specification is replayed, and after the final page has been retrieved (and tidied), the extraction expressions are evaluated to extract the desired content by an XSLT (see, e.g., http://www.w3.org/TR/xslt) processor such as XT (see, e.g., http://www.jclark.com/xml/xt.html) or Xalan (see, e.g., http://xml.apache.orq/xalan-j/overview.html). The extracted content is then returned to the client.

To allow access to diverse devices, the presence is assumed of appropriate gateways, earlier noted, that perform protocol conversion to and from HTTP, as well as the necessary transcoding of content retrieved from the Web view server 101. Thus, the WAP proxy 105 allows access to WAP-enabled devices, the Voice gateway 109 enables voice access to Web content through telephone sets, and a specialized PDA proxy allows access to PDAs.

It should be noted that all processing (retrieval and extraction) is done at the Web view server 101. Only select portions of Web pages are returned to the requesting client, effectively giving users one-click access to desired content, and considerably reducing communication between the client and the Web view server 101. This feature is especially useful in wireless environments where users must access the Web through high-latency, low-bandwidth connections and where some navigation steps (e.g., those involving Javascript) are impossible. Further, if the desired content is to be sent to a handheld device or via a voice interface, the task of transcoding the content becomes much easier since only a portion of the final page needs to be transcoded, and none of the intermediate pages.

Since Web pages may change between the time of creation and execution of a Web view, the system uses techniques to ensure that replaying a sequence of recorded actions will lead to the intended page, and that the correct fragments are extracted—even when the underlying pages are modified. Usually, changes to Web pages do not pose problems to a user browsing the Web, but they do present a challenge to a system that performs automatic navigation. In a sequence of recorded browsing actions, some links may contain embedded session ids, and forms may contain hidden elements that change from one interaction to the next. Thus, for each user action during replay, the Web view system must locate the correct object (link, form or button) to be operated on, which can be challenging in the presence of changes to Web pages (e.g., addition/removal of banner ads). Moreover, any algorithm used to determine the new position of the object on the changed page should preferably be reasonably fast, since it needs to be executed for every recorded user action. Hence, algorithms that require expensive parsing or pattern matching cannot be relied upon. As discussed in the afore-noted and incorporated paper entitled “Automating Web Navigation with the WebVCR,” and the afore-noted and incorporated co-pending patent applications entitled “Method and Apparatus for Web-Site-Independent Personalization From Multiple Sites Having User-Determined Extraction Functionality” and “Method and Apparatus for Web-Site-Independent Personalization From Multiple Sites Having User-Determined Individual Refresh Rates”, during replay, if an exact match for a navigation action cannot be found in a page, heuristics (and optionally, users' hints) are an effective means to find the closest match for the action.

Extraction expressions also need to be made robust to changes to Web pages. For example, in the XPath expression (1) above, if the position of the center tag containing the desired tables changes (e.g., a new preceding sibling center tag appears in the document), the expression will no longer retrieve the correct tables. Instead of absolute positions of nodes, the specification needs to include other information that helps the system uniquely identify components to be extracted, even if the node positions happen to change. For instance, the XPath expression (2) specifies tables that contain the “Price” or “Option” string—this expression would still retrieve the correct itineraries even if new center tags are added. How these expressions can be automatically generated will be discussed hereinafter.

Even though the heuristics that have been developed are robust to minor changes in the page structure, they can still break if the page structure changes radically. In such cases, a mechanism to detect and report errors to the client is needed so that during replay, if the Web view player is not able to locate an object involved in a recorded action, it suspends the replay and notifies the user. The user may then re-record the smart bookmark (to correct the problematic step) before the corresponding Web view is used again. Similarly, if the result of applying the XPath extraction expression to the final page returns nothing, the system reports “not found”. Depending on what is sought, this may be an error. It may also mean that what is sought—e.g., a column by a particular columnist—may not be available at present, but might well be tomorrow. It is also possible that the XPath expression returns an undesired object (if the page structure changes radically). In such cases, the user may need to correct the extraction expression.

A feature of smart bookmarks is the ability it gives users to change the input parameters used during navigation at each replay. For example, in the Travelocity example, if the user wants to check airfares on different travel dates, he need not record a new smart bookmark. Instead he can easily parameterize his smart bookmark. Parameterization is possible due to the robustness features of smart bookmarks, and their ability to navigate through dynamic pages. As described in the afore-noted co-pending patent application “Method for Providing Fast Access to Dynamic Content on the World Wide Web,” the implementation of smart bookmarks allows users to specify whether form elements should be automatically filled, or whether the user needs to provide them during replay. In the latter case, the replay stops at each page where attributes need to be inputted. This approach works well if replay takes place at a desktop, but may not be feasible in a thin-client environment (as these pages would have to be shipped to the client). Instead, the Web view engine generates a page where a user can specify the values of all parameters required for navigation steps. The user-specified values are then fed into the smart bookmark at the appropriate times during replay.

To support reliable parameterization of Web views, two issues should preferably be resolved: internal attribute names that are un-descriptive and invalid selections. Consider for example the page at the Travelocity Web site where a user specifies his itinerary details. The internal name for the departure month attribute is depdtmn1, which can be hard to identify. Also month values must have a specific format, e.g., April is represented by “Apr”, and if the user inputs “April”, the submission will fail. The WebVCR component of the Web view system can be extended to allow users to edit input attributes directly in the Web view. At recording time, users can specify mappings from internal names to more descriptive tags of their choice. In addition, extra information is saved for elements (e.g., all values in a selection list are saved) so that inputs can be checked for validity. This additional information can be useful for transcoding Web views, to be discussed hereinafter. Checking for validity of value, however, is only possible for elements such as selection lists and radio buttons, where a domain is well defined, and is not possible for text fields. Thus, even though the likelihood of failures can be reduced, they cannot be entirely avoided. It should be noted that parameterization only works reliably for deterministic sites. If there are different navigation paths for different values (or combination of values) of parameters, it will invariably fail when an alternate path is taken.

As discussed hereinabove, writing robust XPath expressions can be an involved task, not for naive users. A GUI that produces clippings automatically is thus preferable. Such a GUI allows users to choose a logical section of a Web page (e.g., a table, a paragraph) to extract and produce the appropriate XPath.

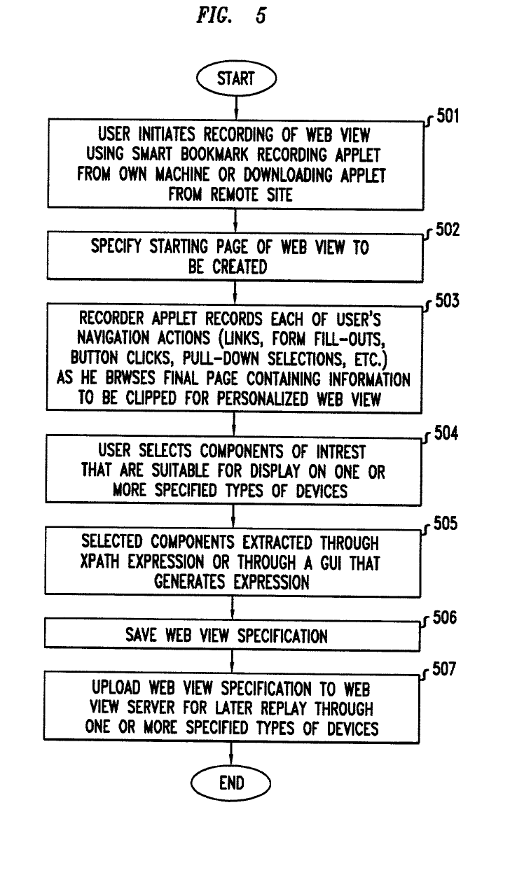

If a user chooses a non-tabular entity (e.g., a paragraph), the GUI asks for predecessor and successor text. The system then determines whether the predecessor (successor) text is within the selected page section or not. Using this information, an XPath expression is automatically generated. If the user chooses a table, the GUI asks him to specify the first row of the table that he is interested in, whether that row contains column labels, and if so, which column labels are of interest. Identifying the first row of interest within the table allows clipping to eliminate elements within the table that are of no interest (e.g., links included in the table simply for layout purposes). FIG. 4 shows a Yahoo! Car page 401 listing used cars in New Jersey. For this exemplary page, the user might specify the row containing DATE as the first row of interest, that that row contains column labels, and that the columns MAKE/MODEL, YEAR, PRICE, and MILES are of interest. The GUI also allows the user to optionally specify a phrase immediately prior to the chosen row (e.g., the word “Showing” in FIG. 4). The user may similarly specify a phrase in the text immediately past the last row he is interested in clipping. If none is specified, the system assumes that all rows are of interest. The GUI also asks him to identify the row labels that are of interest (if any) and whether the table is laid out row-wise (e.g., as in Yahoo! stock quotes) or column-wise (e.g., as in Quicken stock quotes). This information is very valuable for transcoding data for output to a small screen device or a telephone.

Since similar techniques are used to generate a robust XPath expression for both a column-wise and row-wise layout, only XPath generation for the latter will be described. For both, the GUI can generate robust clippings in XPath—clippings that survive significant changes to the HTML structure that leave the form of the table of interest form alone. For instance, the table can move from being top-level to being nested several levels deep in another table or vice versa and the XPath expression will continue to work properly. The following form of XPath expression is used for row-wise layout with a user-specified first row:

(//table/tr/td[contains(string(),‘<USER-SPECIFIED-LABEL>’) and not(descendant::table)]/parent::tr) [1] (3)

The expression looks for a table containing a row with “<USER-SPECIFIED-LABEL>” (e.g., “YEAR”) as a data item. The “not(descendant::table)” part makes ensures that the clipping gets the most deeply nested table for which such a row exists. Without it, when the table of interest is embedded inside another table, the expression would retrieve the containing table. XPath finds the outermost entity matching an expression when going down the tree (and the most deeply nested element matching an expression when going up). The clipping grabs that header row (retrieved using parent::tr) and succeeding rows. Starting at the header row skips extraneous information preceding the proper table content. It should be noted that column and row clipping (if any) is a post-processing step on the XHTML returned by the XPath application.

The system allows users to specify a lot of information. However, all the information requested other than choosing the component to clip is optional. The more information provided, however, the more robust, the clipping will be. Also, the information about row-wise vs. column-wise layout is valuable information that can be passed to the transcoder. Without it, the transcoder must make an informed guess as to how the table is structured using a technique such as described by J. Hu, R. Kashi, D. Lopresti, and G. Wilfong, in “Medium-independent Table Detection,” Proc. Of Document Recognition and Retrieval VII (IS&T/SPIE Electronic Imaging), Vol. 3967, pp. 291-302, 2000. Having the user specify this information increases the likelihood that their custom content will be transcoded in a meaningful form.

The Web view system function as a Web service, and as shown in FIG. 1, the destination for a personalized Web view containing clipped content can be any user-agent that understands HTTP (e.g., a browser on a user's desktop). As discussed and shown in FIG. 1, the Web view server 101 can be used in conjunction with various gateways and transcoding proxies to provide content to devices that do not handle HTTP/HTML, such as the WAP proxy 105, the PDA proxy 107 and the voice gateway 109.

As previously noted, there are many benefits to using the Web view server 101 for delivering information to diverse types of terminals. By offloading all processing and most network communication to the server, it fits well the thin-client architecture used for wireless devices. In addition, by customizing and filtering content, it can significantly simplify Web pages, making the job of the transcoding proxies a lot easier.

Focusing on the Wireless Application Protocol, the WAP is based on a 3-tier architecture where the central component, the WAP proxy 105, is responsible for encoding and decoding requests from wireless devices to Web servers and vice-versa. As shown in FIG. 1, as the user browses the Web through his Web-enabled cellular phone 104, requests are sent to WAP proxy 105. The WAP proxy decodes and executes the requests (e.g., a URL fetch). When a requested document is retrieved from the Web, it is translated by WAP proxy 105 into WML (Wireless Markup Language), appropriately encoded, and returned to the phone. Since WAP proxies talk HTTP and HTML, it is straightforward to use any existing WAP proxy together with a the Web view server 101.

WAP provides a push framework that can be used in conjunction with the Web view server's push mode to provide batch/asynchronous content retrieval. The usage scenario is as follows. An end user requests a clipping from the Web view server 101 by specifying the URL of the clipping and optionally a set of parameters (e.g., the frequency of push). Web view server 101 then acts as a push initiator, periodically retrieving and filtering the specified content, and pushing it to the user's WAP telephone device via a push proxy gateway. Notification services could also be built using the push mechanism. For example, rules could be added to the clipping specification that dictate under what conditions the clipping should be pushed into the device. For devices that do not support a push framework, different mechanisms may be used: specialized servers/gateways could be layered on top of the Web view server to send information to pagers, email addresses, or convert content to speech and send it to a voice mailbox.

To enable secure e-commerce services, and to allow end users to access sensitive information (e.g., 401(k) balance), a mechanism that provides security between the WAP device and the back-end Web sites is needed. Since the Web view server executes requests on the user's behalf, it is not possible to establish an end-to-end secure connection. Two secure connections are thus used: one between the WAP device 104 and the Web view server 101, and another between the Web view server 101 and the back-end Web site (not shown). For WAP devices, this requires WTLS (Wireless Transport Level Security) to provide application-level security, rather than only secure connections between the user-agent and the WAP proxy. In this scenario, for devices that cannot handle HTML, the task of transcoding the request/response is performed at the Web view server 101, since a separate WAP proxy would be unable to access the encrypted data flowing from the Web view server to the WAP device.

FIG. 5 is a flowchart that summarizes the steps used to create a personalized Web view for diverse terminals in accordance with the present invention. At step 501, the user initiates recording of the Web view using a smart bookmark recording applet that is stored in his own desktop machine or that is downloaded from a remote site. At step 502, the starting page of the Web view being created is specified if the final page from which information is to be extracted to form the personalized Web view cannot be reached directly. At step 503, the recorder applet records each of the user's navigation actions as he browses to the final page containing the information to be clipped for the personalized Web view. These navigation actions include, for example, links taken, form filled out, button clicks, and selections from pull-down menus. At step 504, the user selects the components of interest on the final page and that are suitable for display on one or more specified types of devices. At step 505, the selected components are extracted through one or more specified XPath expressions or through a GUI that generates the expressions. The user may also optionally specify that only certain content returned by the XPath (e.g., only certain rows of a table) is of interest. At step 506, the Web view specification is saved. This specification includes both the smart bookmark to access the final page and the extraction expressions that are associated with one or more specified diverse types of devices. At step 507, the Web view specification is uploaded to the Web view server for later replay through one or more of these specified types of devices.

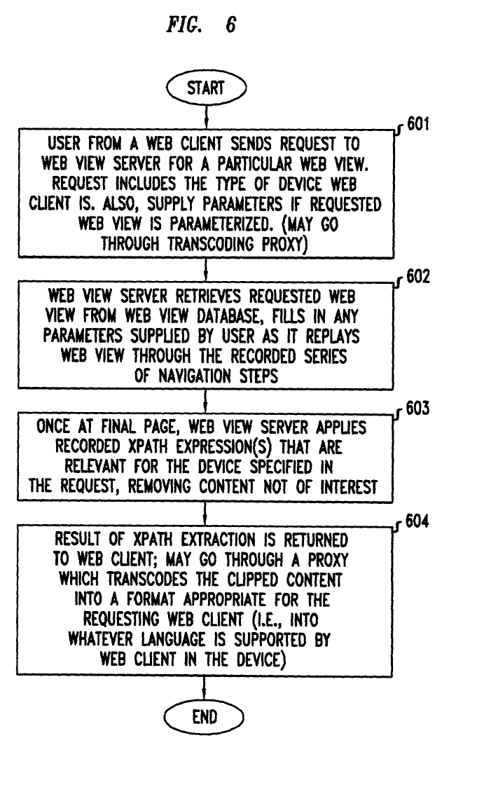

FIG. 6 is a flowchart that summarizes the steps for accessing and replaying a Web view from a specified type of device, in accordance with the present invention. At step 601, the user, from his Web client, sends a request to the Web view server for a particular Web view. Included within the request is what type of device the Web client is. Also, if the requested Web view is parameterized, the parameters are supplied as part of the request. The type of device information can be encoded in the URL or in a GET or POST statement as a parameter. The parameterized parameters could also be provided to the Web view server through an encoded URL or in a form interface that is provided to back to the user's device when the Web view URL is entered. The user would then fill in each of these parameters in the form and forward them to the server. The request may go through a transcoding proxy. It should be noted that the user who accesses a personalized Web view from the Web view server does not necessarily have to be the same person who created the Web view. At step 602, the Web view server retrieves the requested Web view from its Web view database, filling in any parameters supplied by the user as it replays the Web view through the recorded series of navigation steps. At step 603, once the final page is reached, the Web view server applies the recorded XPath expressions in the Web view specification that are applicable to the device specified in the request. The resulting content is then further processed to remove uninteresting content (if any) by traversing the parsed document representation and including only the interesting parts of the tree to the document being generated. At step 604, the resulting generated document is returned to the Web client. When it is returned to the client, the Web view may go through a proxy, which transcodes the clipped content into a format acceptable to the requesting client. Thus, the Web view returned from the Web view server is transcoded into whatever language that is supported by the Web client in the device.

As previously noted, the present invention can be used in conjunction with VoiceXML. VoiceXML has recently been proposed as a standard XML-based markup language for interactive voice response (IVR) systems. VoiceXML replaces the familiar HTML interpreter (Web browser) with a VoiceXML interpreter and the mouse and keyboard with the human voice. As noted by B. Lucas in “VoiceXML for Web-Based Distributed Conversational Applications,” Commun. ACM, 43(9): 53-57, 2000, “the Web revolution largely bypassed the huge market for information and services represented by the worldwide installed base of telephones, for which voice input and audio output provide the sole means of interaction”. VoiceXML has the potential to remedy this oversight.

It should be noted that some Web content is available by phone already. Also, some voice browsers and HTML-to-VoiceXML transcoders have been built. However, the effectiveness of such systems is compromised in the presence of improperly structured documents. Furthermore, much of the information on a Web page is not related to the primary purpose of the person browsing to the page (e.g., ads, links to other parts of the site). Listening to such pages transcoded into voice is thus usually not a pleasant experience, thereby substantially reducing the utility of such browsers. By simplifying the content retrieval process, and filtering out uninteresting components of Web pages, the Web view architecture of the present invention can render the desired information in voice in a terser, far more user-friendly manner than more general voice browsers can.

It should be noted that transcoding even simplified versions of HTML pages into VoiceXML presents interesting challenges. The serial nature of voice interfaces is in many ways incompatible with visual interfaces. For example, voice interaction becomes intractable if users are presented with too many choices (e.g., a list with all 50 American states). In contrast, visually displaying many choices may be inconvenient, but it is still manageable. A voice view architecture and an approach that provides voice access to Web views is described below.

FIG. 1 shows access from various devices to the Web view server 101 through different transcoding proxies. The transcoding functionality can also be incorporated into the Web view server 101, with the added advantage that the user can now annotate the Web view and supply extra information that can be used in the transcoding process to produce better quality content, and a more user-friendly experience. The main drawback of this tight-coupling it that the transcoding engine and server must agree on a set of annotations. If separate parties develop them, this may discourage such an architecture, unless a standard for such annotations exists.

The architecture of an engine that transcodes clipped HTML content into VoiceXML will be described as well as how this engine can be combined with the Web view server to create a Web view for voice. The presence is still assumed of a voice gateway 105 (running a VoiceXML interpreter) that connects the PSTN network to the World Wide Web 102. The user calls a phone number, and the VoiceXML interpreter in voice gateway 105 requests the Web view server 101 for any VoiceXML dialogs to be played to the user.

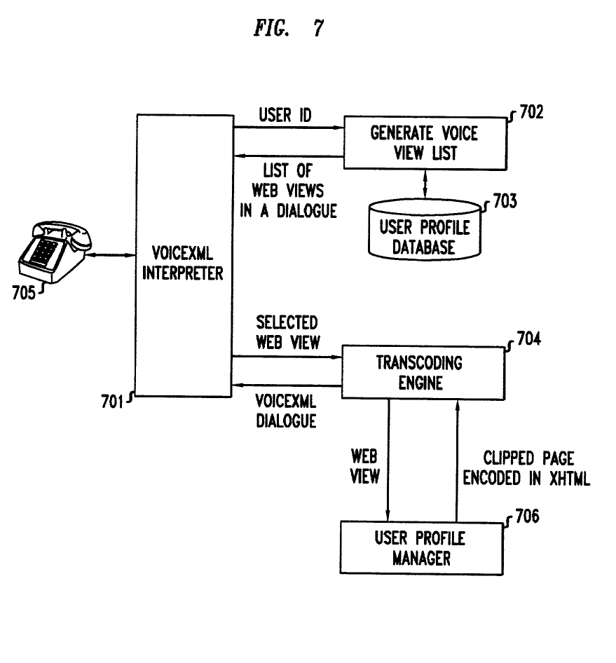

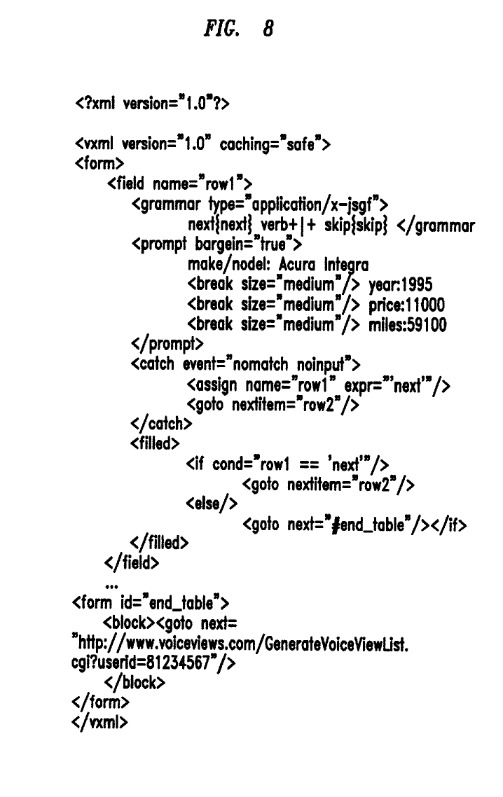

The voice transcoding architecture is shown in FIG. 7. It includes the VoiceXML interpreter 701, a GenerateVoiceViewList module 702, a user profile database 703, a transcoding engine 704 and a user profile manager 706. The usage scenario is as follows. When the user calls a special phone number from his telephone 705, a fixed caller identification VoiceXML dialogue is started. The dialogue attempts to identify the user using his caller ID (which it uses as userid); if that is not available, the system interrogates the user for the userid. Once the userid is obtained, the list of Web views associated with that user is looked up (via GenerateVoiceViewList module 702) from the user profile database 703, and a VoiceXML dialogue is generated that prompts the user to select between one of his recorded Web views. The user can then make his selection via touch-tone or spoken input. Once the user makes a choice, the VoiceXML interpreter 701 passes the Web view information to the transcoding engine 704, which in turn queries the Web view execution engine to execute the Web view. The transcoding engine 704 converts the clipped content into VoiceXML, utilizing the extra annotations supplied with the Web view.

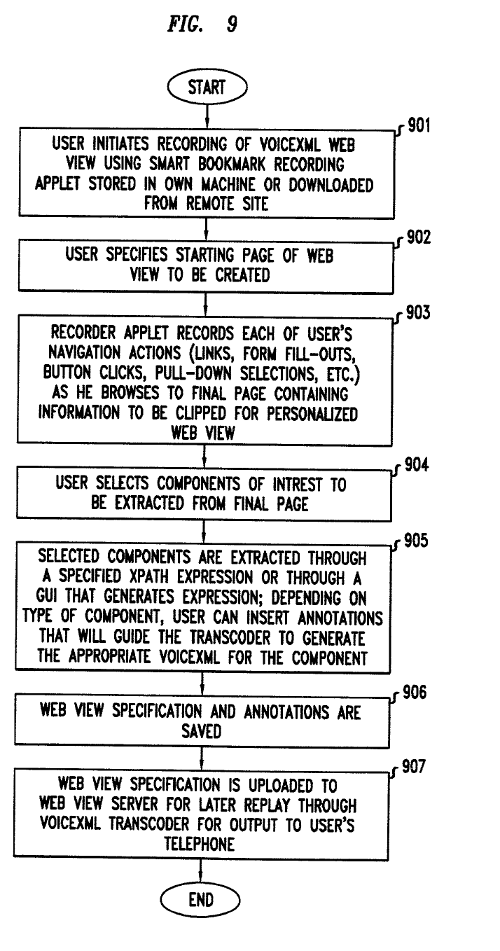

FIG. 8 shows the VoiceXML dialogue generated by the transcoding engine 704 for the clipping (appropriately tidied) of the exemplary Yahoo! car page shown in FIG. 4. In the dialogue, each car listing is transcoded as a field of a VoiceXML form. The form contains all the data transcoded from a single top-level table. The transcoded output could also have been outputted as a single block so that the entire contents would have been read as a unit using TTS processing, but that would have given the user no option but to listen to the whole table being read or to hang up. As formulated in FIG. 8, the script listens for special keywords, namely “next” and “skip”, allowing the user to quit hearing details of a single row or of the rest of the table. If the user says nothing (noinput) or something incomprehensible (nomatch), the script goes to the next row.

In order to intelligently transcode a table, Web view annotations are helpful. A table may be organized row-wise, column-wise, or neither (e.g., being used simply for layout)—and each requires substantially different transcoding. For instance, if the table in FIG. 4 were treated as being there simply for layout, the transcoded voice would be partially incomprehensible. For example, it would say: “Showing 1-15 of 34 listings Previous Ads Next Ads DATE MAKE MODEL YEAR PRICE FULL LISTING Oct. 26, 2000 Acura Integra 1995 11000,” etc. The knowledge that MAKE/MODEL, YEAR, PRICE, and MILES are the columns to transcode and that the table is laid out row-wise allows the transcoder to pair headers and values together (as defined in FIG. 8), and to eliminate uninteresting data (e.g., DATE, FULL LISTING columns). Similar techniques are useful for small screens (e.g., on WAP phones) even where tables are supported, because they produce something much more readable than tables with rows that wrap lines.

Also useful is the information stored for the parameterization of a Web View for entities such as radio buttons and pull-down lists to enable users to specify their corresponding values. For these entities, parameterized smart bookmarks store the list of acceptable choices that the user may enter. (In unparameterized bookmarks this information is not required since no choices are presented to the user). Not only does this information allow the system to prevent bad user-input, it also makes it possible to transcode the parameterized data in a more convenient form. Rather than reading out each possible value with an associated number and having the user enter that number by voice or touch-tone, the system can generate a grammar that only accepts the legitimate choices. Since the lists are generally small, voice recognition works reasonably well. For example, when giving a user the choice to enter the name of a state, allowing the user to immediately say “WV” is far more convenient than asking him to wait to hear and respond to “47 WV”. Due to the limitations of voiceindependent recognition systems, however, this technique does not work well for text fields where no information about the domain is available, or when domains are large.

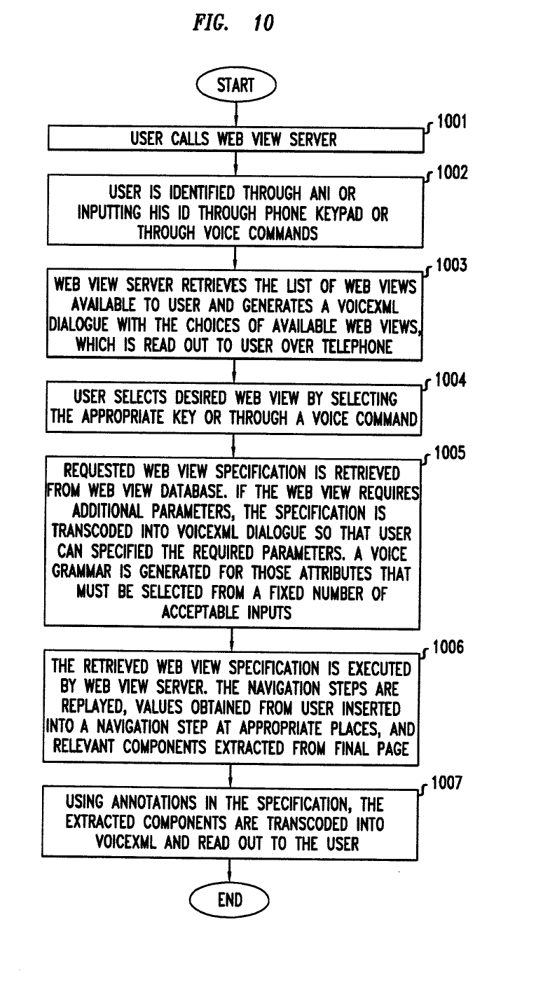

FIG. 9 is a flowchart that summarizes the steps of creating a Web view for VoiceXML applications in accordance with the present invention. At step 901, the user initiates recording of the Web view using a smart bookmark recording applet that is stored in his own desktop machine or that is downloaded from a remote site. At step 902, the starting page of the Web view being created is specified if the final page from which information is to be extracted to form the personalized Web view cannot be reached directly. At step 903, the recorder applet records each of the user's navigation actions as he browses to the final page containing the information to be clipped for the personalized Web view. These navigation actions include, for example, links taken, forms filled out, button clicks, and selections from pull-down menus. At step 904, the user selects the components of interest to be extracted. At step 905, selected components are extracted through a specified XPath expression or through a GUI that generates the expression. Also, depending on the type of the component, the user can insert annotations that will guide the transcoder to generate the appropriate VoiceXML for the component when the Web view is replayed through VoiceXML. Example of these annotations include whether a table should be read row-wise or column-wise, and what labels that are associated with a table are of interest. These annotations are also useful to improve the robustness of the voice view. At step 906, the Web view specification and annotations are saved. At step 907, the Web view specification is uploaded to the Web view server for later replay through the VoiceXML transcoder for output to the user's audio terminal, such as a telephone.

FIG. 10 is a flowchart that summarizes the steps of replaying a stored Web view for VoiceXML. At step 1001 the user, using his telephone, for example, calls the Web view server. At step 1002, the user is identified through ANI or by inputting his ID through the phone keypad or through voice commands. At step 1003, the Web view server retrieves the list of Web views available to the user and generates a VoiceXML dialogue with the choices of the available different Web views, which are read out to the user over the telephone. At step 1004, the user selects the desired Web view by selecting the appropriate key or through a voice command. At step 1005, the requested Web view specification is retrieved from the Web view database. If the Web view requires additional parameters, the specification is transcoded into a VoiceXML dialogue so that the user can specify or select the required parameters. For those attributes that must be selected by the user from among a fixed number of acceptable inputs, a voice grammar is generated of acceptable inputs for that attribute. For each such attribute with an associated grammar, the user's voice input is matched with one of the acceptable inputs and, if none is found, the user is requested to re-input his selection. At step 1006, the Web view server executes the retrieved Web view specification. The navigation steps are replayed, the values obtained from the user being fed into a navigation step at the appropriate place as that navigation step is being played. When the final page is reached, the relevant components are extracted. At step 1007, using the annotations in the specification (e.g., read row- or column-wise, labels, etc.), the extracted components are transcoded and read out to the user.

The VoiceXML embodiment of the present invention advantageously enables an end-user to create and maintain a personalized voice-enabled view of one or more Web sites, which can be accessed through voice interfaces. These customized voice Web views provide shortcuts to existing Web content and services in which a user (or a group of users) is interested in retrieving through a voice interface. By allowing a user to create his own voice Web view, a service is provided that is personalized for that user and is not restricted to a set of supported Web sites. Advantageously, Web sites need not be redesigned—voice Web views can be created for existing Web sites (and HTML content) and no changes are required to these Web sites. Further, there is no need to hand-code a voice interface for each individual service or content—voice Web views are created interactively through a point and click interface and required code is automatically generated. A creator of a voice Web view is also able to annotate the view with information that will lead to better transcoding and better user experience, as for example as noted above, by specifying whether a table should be read row-wise or column-wire, and which cells in a table are the headers.

Supporting Web views for telephonic access to the Web using VoiceXML is only one embodiment of the methodology described above. Those skilled in the art could produce variants of Web views that support a wide variety of electronic devices as for example, thermostats, microwaves, refrigerators, that speak a protocol supported by the device using the methodology taught herein.

The foregoing merely illustrates the principles of the invention. It will thus be appreciated that those skilled in the art will be able to devise various arrangements that, although not explicitly described or shown herein, embody the principles of the invention and are included within its spirit and scope. For example, each Web clipping may include information content from more than source Web page. Also, although XPath is used in the exemplary embodiments described above, other types of extraction functionalities not limited to those even known at the time of this invention are intended to be included within the scope of the present invention. Furthermore, all examples and conditional language recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views embodying the principles of the invention. Similarly, it will be appreciated that any flow charts, pseudocode, and the like represent various processes which may be substantially represented in computer readable medium and so executed by a computer or processor, whether or not such computer or processor is explicitly shown.

The functions of the various elements shown in the FIGS. may be provided through the use of dedicated hardware as well as hardware capable of executing software in association with appropriate software. When provided by a processor, the functions may be provided by a single dedicated processor, by a single shared processor, or by a plurality of individual processors, some of which may be shared.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

The invention claimed is:

1. A method comprising:
receiving a request from an originating device for a particular personalized Web view, the request indicating the type of the originating device;
retrieving a stored specification of the Web view;
accessing a particular Web page indicated in the specification of the Web view;
extracting in accordance with the specification at least one component on the accessed Web page that is relevant for the type of device indicated by the request and is associated in the specification with that type of device; and
returning the extracted component to the originating device.

2. The method of claim 1 wherein accessing a particular Web page comprises performing a series of navigation steps recorded in the specification from a first Web page to a final Web page from which the component is extracted.

3. The method of claim 2 further comprising receiving from the Web client one or more parameters that are associated with one or more of the navigation steps, and inserting each received parameter in its associated navigation step as that navigation step is performed.

4. The method of claim I wherein the originating client is a Web client.

5. The method of claim 4 further comprising transcoding the extracted component into a language that is supported by the Web client.

6. The method of claim 1 wherein the specification includes at least one XPath expression for extracting the component.

7. The method of claim 1 wherein the originating client is a telephone.

8. The method of claim 7 further comprising transcoding the extracted component into a voice-response system format.

9. The method of claim 8 wherein the voice-response system format is VoiceXML.

10. The method of claim 1 wherein the originating device is an electronic device that communicates through a protocol supported by the electronic device.

11. The method of claim 10 further comprising transcoding the extracted component into the protocol supported by the electronic device.

12. A method of creating a personalized Web view comprising:
recording one or more navigation steps to reach a final Web page containing at least one component of interest;
generating at least one extraction expression that extracts from the final Web page the component of interest and which is relevant for presentation on at least one specific type of device; and
saving a specification that includes the one or more navigation steps to reach the final Web page and the one or more extraction expressions, the specification including an association between the specific type of device and the one or more extraction expression.

13. The method of claim 12 wherein recording the one or more navigation steps comprises recording a series a navigation steps starting at a first Web page and ending at a final Web page on which the component of interest is located.

14. The method of claim 12 further comprising uploading the specification to a server for later replay through the specific type of device.

15. The method of claim 13 wherein each of the one or more navigation steps comprise one or more of form fill-outs, button-clicks, links, selection from pull-down lists, or any action that exists in the traversed Web page.

16. The method of claim 12 wherein the extraction expression is an XPath expression.

17. The method of claim 12 wherein the extraction expression is generated by a GUI.

18. The method of claim 14 wherein the specific type of device is a telephonic device and annotations are associated in the specification with the extraction expression for the selected component for guiding a transcoder in generating an appropriate voice-response system format signal when a user later accesses the server and replays the specification.

19. A memory for storing a specification of a personalized Web view comprising:
a data structure stored in the memory, said data structure including information for automatically accessing a particular Web page that has been selected by a user from essentially any Web server, information for extracting at least one user-selected component on the accessed page that is relevant for display on at least one specific type of device; and an association between the specific type of device and the extracted component.

20. The memory of claim 19 wherein the information for automatically accessing a particular Web page comprises information for performing a series of navigation steps from a first Web page to a final Web page from which the user-selected component is extracted.

21. The memory of claim 19 wherein the information for extracting the user-selected component is in the form of an XPath expression.

22. A computer readable media tangibly embodying a program of instructions executable by a computer to perform a method of executing a personalized Web view, the method comprising:
receiving a request by a user from an originating device for a particular personalized Web view, the request indicating the type of the originating device;
retrieving a stored specification of the Web view;
accessing a particular Web page indicated in the specification of the Web view; and
extracting in accordance with the specification at least one component on the accessed Web page that is relevant for the type of device indicated by the request and is associated in the specification with that type of device.

23. The media of claim 22 wherein in the method accessing a particular Web page comprises performing a series of navigation steps recorded in the specification from a first Web page to a final Web page from which the component is extracted.

24. The media of claim 23 wherein one or more parameters are associated with one or more of the navigation steps, method further comprising receiving from the user the one or more parameters, and inserting each received parameter in its associated navigation step as that navigation step is performed.

25. The media of claim 22 wherein the method further comprises transcoding the extracted component into a language that is supported by the Web client.

26. The media of claim 22 wherein in the method the specification includes at least one XPath expression for extracting the component.

27. The media of claim 22 wherein the method further comprises transcoding the extracted component into a voice-response system format.

28. Apparatus comprising:
means for receiving a request from an originating device for a particular personalized Web view, the request indicating the type of the originating device;
means for retrieving a stored specification of the Web view;
means for accessing a particular Web page indicated in the specification of the Web view;
and means for extracting in accordance with the specification at least one component on the accessed Web page that is relevant for the type of device indicated by the request and is associated in the specification with that type of device.

29. The apparatus of claim 28 wherein the means for accessing a particular Web page performs a series of navigation steps recorded in the specification from a first Web page to a final Web page from which the component is extracted.

30. The apparatus of claim 29 wherein one or more parameters are associated with one or more of the navigation steps, the accessing means inserting each parameter received by a user in its associated navigation step as that navigation step is performed.

31. The apparatus of claim 28 wherein the originating client is a Web client.

32. The apparatus of claim 31 further comprising means for transcoding the extracted component into a language that is supported by the Web client.

33. The apparatus of claim 28 wherein the extracting means uses an XPath expression in the specification for extracting the component.

34. The apparatus of claim 28 wherein the originating client is a telephone and the apparatus further comprises means for transcoding the extracted component into a voice-response system format.

35. The apparatus of claim 34 wherein the voice-response system format is VoiceXML.

36. The apparatus of claim 28 wherein the originating device is an electronic device that communicates through a protocol supported by the electronic device and the apparatus further comprises means for transcoding the extracted component into the protocol.
